(19) United States
(12) Patent Application Publication
(10) Pub. No.: US 2024/0273223 A1
(43) Pub. Date: Aug. 15, 2024

(54) METHOD AND SYSTEM FOR ENFORCING SECONDARY USAGE CONTROL ON DATA ANALYTICS SERVICE

(71) Applicant: NEC Laboratories Europe GmbH, Heidelberg (DE)

(72) Inventors: Flavio CIRILLO, Heidelberg (DE); Bin CHENG, Heidelberg (DE)

(21) Appl. No.: 18/291,234

(22) PCT Filed: Jul. 27, 2021
(86) PCT No.: PCT/EP2021/070942

§ 371 Date: Jan. 23, 2024

(51) Int. Cl. G06F 21/62

(52) U.S. Cl. CPC G06F 21/6218

(57) ABSTRACT

A computer-implemented method of enforcing secondary data usage control includes providing, via a policy manager, secondary data usage policies of a data owner of original data. The method provides, via a service orchestrator, a description of a service intended to be applied by a data consumer to input data contained in the original data, the service including one or more data processing functions. The method matches, by a secondary usage control policy enforcement point (SUC PEP) component, the secondary data usage policies provided via the policy manager with the input data or specific classes of the input data and/or with data processing functions of the service provided via the service orchestrator. The method applies, by the SUC PEP component, the matched secondary usage policies on the secondary data.

### CROSS REFERENCE TO RELATED APPLICATIONS

This application is a U.S. National Phase application under 35 U.S.C. § 371 of International Application No. PCT/EP2021/070942, filed on Jul. 27, 2021. The International Application was published in English on Feb. 2, 2023 as WO 2023/006182 A1 under PCT Article 21(2).

### FIELD

The present invention generally relates to the technical field of data protection. More specifically, the invention relates to a computer-implemented method and a system for enforcing secondary data usage control.

### BACKGROUND

Data sharing between companies is fostered by both data consumers and data providers for mutual benefits to reduce costs for new services development and create new data business models.

Sharing infrastructures and platforms that are already available in the market are not yet generating an automatic data marketplace on a global scale. This is due to the data providers' reluctance to lose control over their owned data after data is shared. Methods for data usage control have been proposed to solve the direct usage of data by a data consumer (as shown in FIG. 1 between data provider/owner 100 and a first data consumer 110, i.e. company A), but secondary usage control (as shown in FIG. 1 between the first data consumer 110 and a second data consumer 120, i.e. company B) is still an open challenge regarding the control by the original data provider 100 over the secondary data processed by the first data consumer 110. The processed data can still carry sensitive information of the original data provider 100 or it can still be economically linked to data provider business. The General Regulation of Data Protection (GDPR, for reference, see, e.g., Voigt, P., von dem Bussche, A., 2017. The EU General Data Protection Regulation (GDPR). A Practical Guide. Springer Int. Publ. doi: 10.1007/978-3-319-57959-7) also covers this aspect and hinders the business development of companies that consume personal data due to the uncertainty of the consequences if their processed data is shared or sold to third parties.

### SUMMARY

In an embodiment, the present disclosure provides a computer-implemented method of enforcing secondary data usage control, the method comprising: providing, via a policy manager, secondary data usage policies of a data owner of original data; providing, via a service orchestrator, a description of a service intended to be applied by a data consumer to input data contained in the original data, the service including one or more data processing functions; matching, by a secondary usage control policy enforcement point (SUC PEP) component, the secondary data usage policies provided via the policy manager with the input data or specific classes of the input data and/or with data processing functions of the service provided via the service orchestrator; and applying, by the SUC PEP component, the matched secondary usage policies on the secondary data.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating direct usage and secondary usage control of data of a data provider;

FIG. 2 is a schematic view illustrating first data usage control enforcement according to prior art;

FIG. 3 is a schematic view illustrating secondary data usage control enforcement according to prior art;

FIG. 4 is a schematic view illustrating a secondary data usage control system in accordance with an embodiment of the present invention;

FIG. 5 is a schematic view illustrating a secondary data usage control policy enforcement system in accordance with an embodiment of the present invention;

FIG. 6 is a schematic view illustrating a secondary data usage control system with a centralized authority in accordance with an embodiment of the present invention;

FIG. 7 is a schematic view illustrating a secondary data usage control system with a federation of authorities in accordance with an embodiment of the present invention; and

FIG. 8 is a schematic view illustrating secondary data usage control enforcement on digital twins in accordance with an embodiment of the present invention.

FIG. 9 is a schematic view illustrating three industrial companies cooperating with each other in accordance with an embodiment of the present invention.

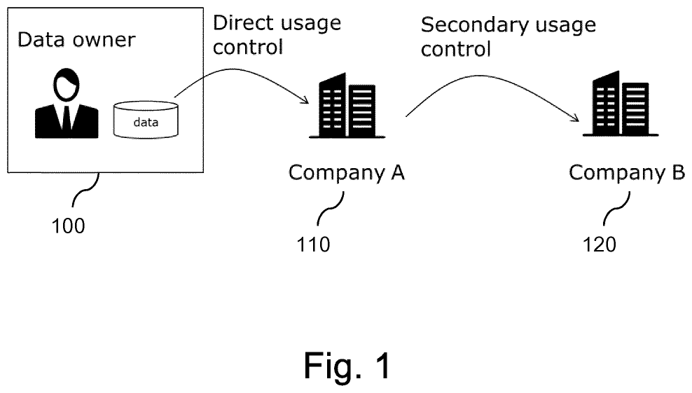

### DETAILED DESCRIPTION

In accordance with an embodiment, the present invention improves and further develops a method and a system of the initially described type in such a way that secondary usage control on data is enforced in a proactive and preventive manner without any direct interaction between data consumers and data providers.

In accordance with another embodiment, the present invention provides a computer-implemented method of enforcing secondary data usage control, the method comprising providing, via a policy manager, secondary data usage policies of a data owner of original data; providing, via a service orchestrator, a description of a service intended to be applied by a data consumer to input data contained in the original data, the service including one or more data processing functions; matching, by a secondary usage control policy enforcement point, SUC PEP, component the secondary data usage policies provided via the policy manager with the input data or specific classes of the input data and/or with data processing functions of the service provided via the service orchestrator; and applying, by the SUC PEP component, the matched secondary usage policies on the secondary data.

Furthermore, in accordance with another embodiment, the present invention provides a system for enforcing secondary data usage control, the system comprising a policy manager configured to provide secondary data usage policies of a data owner of original data; a service orchestrator configured to provide a description of a service intended to be applied by a data consumer to input data contained in the original data, the service including one or more data processing functions; and a secondary usage control policy enforcement point, SUC PEP, component configured to match the secondary data usage policies provided via the policy manager with the input data or specific classes of the input data and/or with data processing functions of the service provided via the service orchestrator, and apply the matched secondary usage policies on the secondary data.

The present invention focuses on the secondary usage control, that is the control on how the processed data produced by a data consumer can be used by a third party complying with the original data provider's policies. Secondary data usage control can happen through legal means rather than technical means as specified in the context of the present invention. In the case of legal enforcement, before any data analytics application is executed, the data consumer negotiates with the data owner for the usage of the data. The data owner, then, expresses his consent on the usage of the data under constraints. The constraints are usually encoded into contracts or policies. In contrast to such legal approach, the present invention proposes a system and a method to enforce in a proactive and preventive manner secondary usage control on input data (specified by a data consumer and contained in the original data) without the direct interaction between data consumers and data providers or, more generally, without the direct intervention of humans in the loop. The advantage is a scalable ecosystem for any kind of data sharing platform with a high degree of automation.

The present invention enforces the control of processed data according to the policies specified by the original data owner. The enforcement happens on services without the involvement of human negotiations and in a preventive and proactive manner (no data is processed if not specified into the policies). Embodiments of the invention enforce the secondary data usage control by a centralized authority or by a federation of authorities (herein sometimes denoted execution environment authority). Embodiments of the invention assume that these authorities are trusted environments that are certified and cannot be tampered (e.g., remotely attested).

According to some embodiments, the present invention provides methods and systems for applying secondary data usage policy that comprise a policy manager holding secondary data usage policies representing the will of the data owners. The solution may further include a storage of data consuming applications in the form of composition of analytics tasks by data consumer. The analytics tasks may be defined by the input data or one or more particular classes of the input data, processing function, and output data.

According to an embodiment, the methods and systems further include matching secondary usage policy with the input data or particular classes of the input data and/or with processing functions of the service. The matched secondary usage policy may be applied on the output data by first deciding and then executing atomic actions that enforces:
a) creating new access or data usage control policies targeting the output data;
b) instructing the system executing the analytics with commands; and/or
c) instructing the component handling the output data.

In the context of above item a.), the present invention provides a method for a data provider to specify policies on original data to be used as policies generator patterns to control the access and usage of any secondary (processed) data derived from the data provider's original data.

According to an embodiment, the present invention provides a method that enforces access and usage policies on secondary (processed) data in a proactive and preventive manner by deciding on and executing atomic actions on the policy manager (e.g., creation of new access, direct usage, and secondary policies), the data manager (e.g., deleting data), and the service orchestrator (e.g., instantiate pre-processing functions). The atomic actions may target the output data generated by services whose description (e.g., input data or class of input data and functions) matches with attributes of the policies.

In the context of the present disclosure, a class of input data may denote a specifically defined subset of the input data. For instance, the input data may be patient data including, e.g., name, address, age, gender, weight and disease(s) of the patients. In this case, each of the listed items may constitute a specific class of input data. In this example, privacy preserving policies may be defined that grant a data consumer, e.g., access to all classes except for the classes ‘name’ and ‘address’.

According to an embodiment, an atomic action may include generating a policy for each set of output data specifying that the respective set cannot be accessed by any third parties except the original data owner and the data consumer. The generated policy may be stored into the policy manager storing.

According to a further embodiment, an atomic action may include generating a command routine for at least one processing node that executes the processing functions of the service to alter the execution of the service. The command routine may be send to an execution environment of the service. For instance, the command routine may be configured to stop and restart a container instance of the service applied to the original data at predefined time intervals.

According to a further embodiment, an atomic action may include modifying the service by prepending a processing function to the original data or appending a processing function to the processed (i.e. secondary) data. For instance, the service may be modified by anonymizing the input data by means of an anonymization function and applying the processing functions of the service to the anonymized data.

According to an embodiment, each of the data analytics functions is described by the data consumer with the input data or one or more particular classes of the input data, the processing function, and output data.

According to an embodiment, each of secondary data usage policies defines the owner of the original data, the input data or one or more particular classes of the input data targeted by the policy, the data consumer to whom the policy applies, at least one specific function targeted by the policy and at least one constraint specifying limitations on the usage of the targeted data.

According to an embodiment, the system is matching a policy with a data analytics function description by:
i) matching the original data specified in the policy with the input data of class(es) of input data of the analytics function description;
ii) matching the analytics function targeted by the policy with the data analytics function used by the service; and
iii) matching the data consumer identity targeted by the policy with the data consumer identity that instantiates the data analytics service.

There are several ways how to design and further develop the teaching of the present invention in an advantageous way. To this end it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

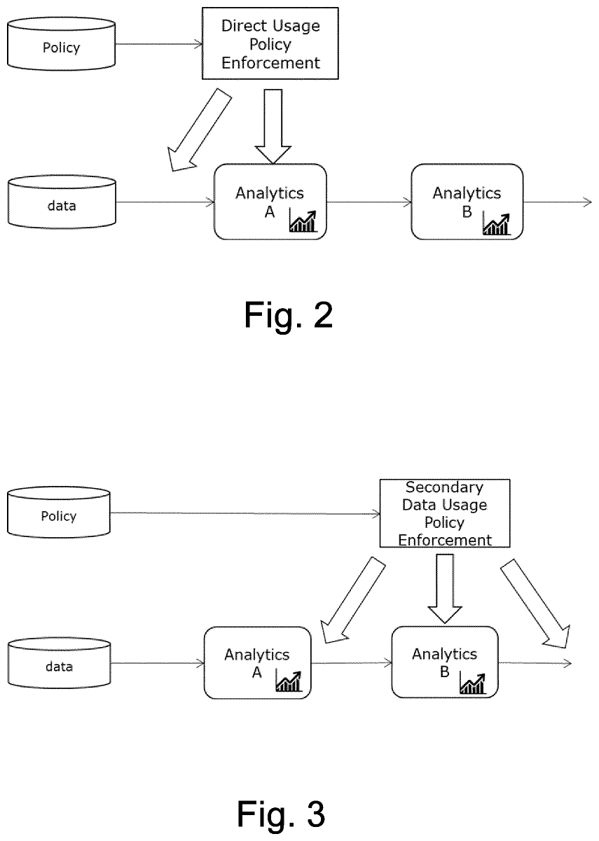

Normal data usage control policy affects the access control and the way it is used by a first consumer analytics, as schematically shown in FIG. 2. Secondary usage control, instead, affects the enforcements on the resulting data of the first analytics, as schematically shown in FIG. 3.

A solution to secondary data usage control usually goes through private negotiations between data owner and data consumers with signed agreements followed by ad-hoc data sharing infrastructure deployment. Each data consuming service is then configured by an administrator to comply with the usage agreements. Controlling the actual enforcing of the agreed policies is done through audits that, however, would spot infringements only after they happened.

To address these issues, embodiments of the present invention provide systems and methods that enforce in a proactive and preventive manner secondary usage control on data without the direct intervention of humans in the loop. The advantage is a scalable ecosystem for a data sharing platform.

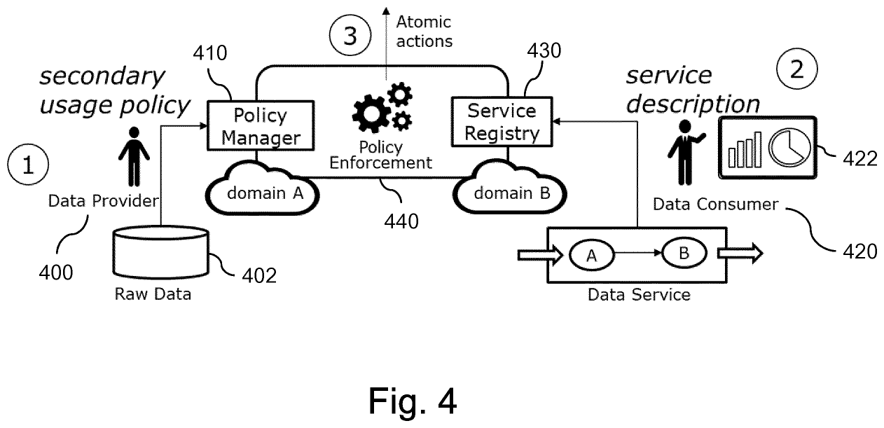

FIG. 4 illustrates the basic workflow of a method to protect secondary data (i.e. processed data from original data) in accordance with an embodiment of the present invention.

According to one aspect (denoted with an encircled 1 in FIG. 4), a data provider 400 holding its original data 402 submits secondary data usage policies protecting its owned data 402 to a policy manager 410. A secondary usage policy might refer to secondary data access, secondary data usage, and/or processed data from secondary data (i.e. transitivity).

According to a further aspect (denoted with an encircled 2 in FIG. 4), a data consumer 420 submits a description of the intended service that will process the original data to a service registry 430. The description of the intended service may be provided in the form of a composition of atomic analytics tasks 422. Each analytics task may be defined by the input data or a specific class of input data, a processing function, and the resulting output data.

According to a further aspect (denoted with an encircled 3 in FIG. 4), a policy enforcement logic 440 decides on atomic actions to be executed. In this context, it may be provided that the policy enforcement logic 440 is configured to match the secondary usage policies (as submitted by the original data owner 400 to the policy manager 410) with the input data or a specific class of input data and/or with processing functions of the service (as submitted by the data consumer 420 to the service registry 430).

Based thereupon, the policy enforcement logic 440 may be configured to apply the matched secondary usage policies on the service output data by deciding on and executing atomic actions, such as creating access or data usage control policies targeting the output data (e.g., a policy stating that service output data cannot be shared with third parties), commanding a certain behaviour to computing nodes executing the analytics (e.g., flush service memory every two hours, instantiate a pre-processing anonymization task). Alternatively, the policy enforcement logic 440 may be configured to apply the matched secondary usage policies on the output data by commanding a certain behaviour to a component managing the service output data (e.g., service output data may be forwarded to original data owner as soon it is generated).

According to an embodiment of the present invention, the data provider 400 may specify secondary data usage policies in the following form that is stored into the policy manager 410:
Who: I.e., indicating the owner of the data.
What: I.e., indicating the data targeted by the policy, e.g., the type of data.
To whom: I.e., indicating the data consumer that targets the policy. This information can be either a specific data consumer identifier or any.
Purpose: I.e., indicating a specific function targeted by the policy. The function can be either a data consuming service name (denoted S hereinafter), a specific atomic task function (named ƒ(⋅) hereinafter), or any.
Constraints: I.e., indicating the limitations on the usage of the targeted data. The limitations may be formed by one or more rules. In this context, a rule is a combination of an action type to be enforced that is configured by action parameters.

According to an embodiment of the invention, a constraint on secondary data may specify a number of different control aspects, including access, data usage, and/or secondary usage (i.e. transitivity). With respect to the access control, it may be provided that the data owner defines secondary data access before the secondary (i.e., processed) data is generated. For instance, access control may specify that processed data can be accessed (e.g., read) only by the data consumers that generated such processed data. The data usage control may specify how the secondary data can be used by a third party, for instance that processed data can be used only if aggregated with other datasets. The secondary usage control might affect all the processed data that directly or indirectly comes from the original data. For instance, secondary usage control may define that all processed data that descend from the original data may be accessible (access control) by the original data owner.

Policies on the secondary data may include, but are not limited to the following examples:

Secondary data may be read by third parties, e.g. a third party may visualize the secondary (processed) data on a dashboard.

Secondary data may be further processed by third parties, e.g. secondary processed data may flow into any analytics service of a third party.

Secondary data may be processed only for a specific purpose, e.g. secondary data can be processed only by a specific service (independently from the third party requesting it).

Secondary data may go through pre-processing, e.g. before flowing into any analytics service the secondary data may be aggregated with other datasets originated from other providers.

Secondary data may go through post-processing, e.g. the final output of an analytics service using the secondary data (for example a time series) may be processed by an aggregation function (for example accumulate data in time windows of 10 minutes and only retrieve an average of the accumulated data).

Secondary data can be used only within the computing premises of the original data provider, e.g. in order for an analytics service to use secondary data it may be executed on a processing nodes directly administrated by the original data provider.

Secondary data can always be accessed by the original data provider, e.g. any processed data by third parties derived from the original data may flow into any analytics of the original data provider.

It is important to note that the original data provider/owner is not required to know the type of secondary data. For example, a data owner sharing the position of her smartphone might specify that any processed data that uses her position information cannot be used by any marketing purposes. As a more concrete example, a data owner shares her position to a navigation system that will use it to monitor the road traffic to better estimate a suggested route. However, the data downer may specify that any traffic information using her data cannot be used by a marketing analytics (e.g. with the purpose of optimal advertisement sign planning on the roadside). The original data owner does not need to specify the traffic information type into her policy since data usage policies will be automatically generated for each service description that will use her data.

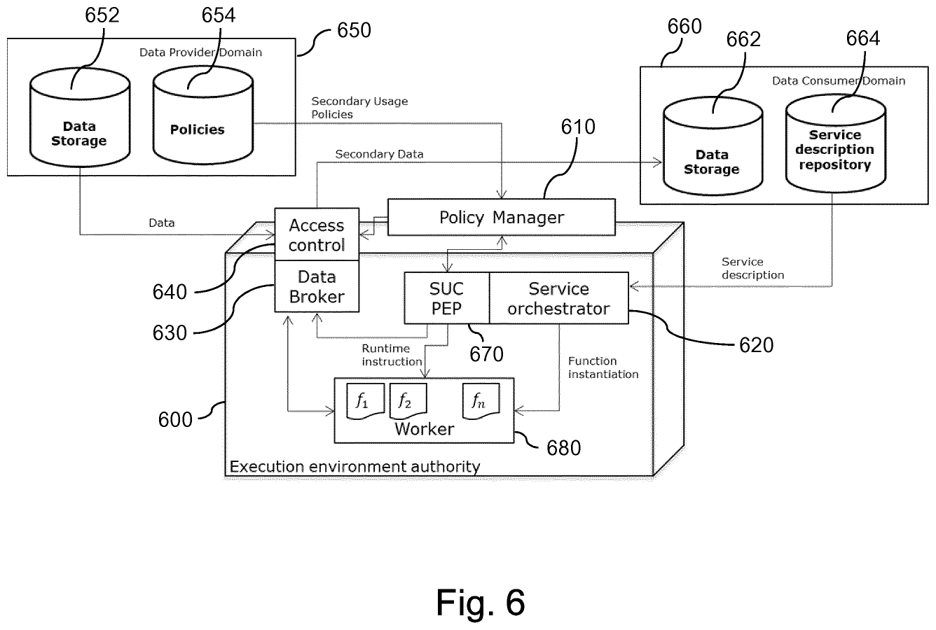

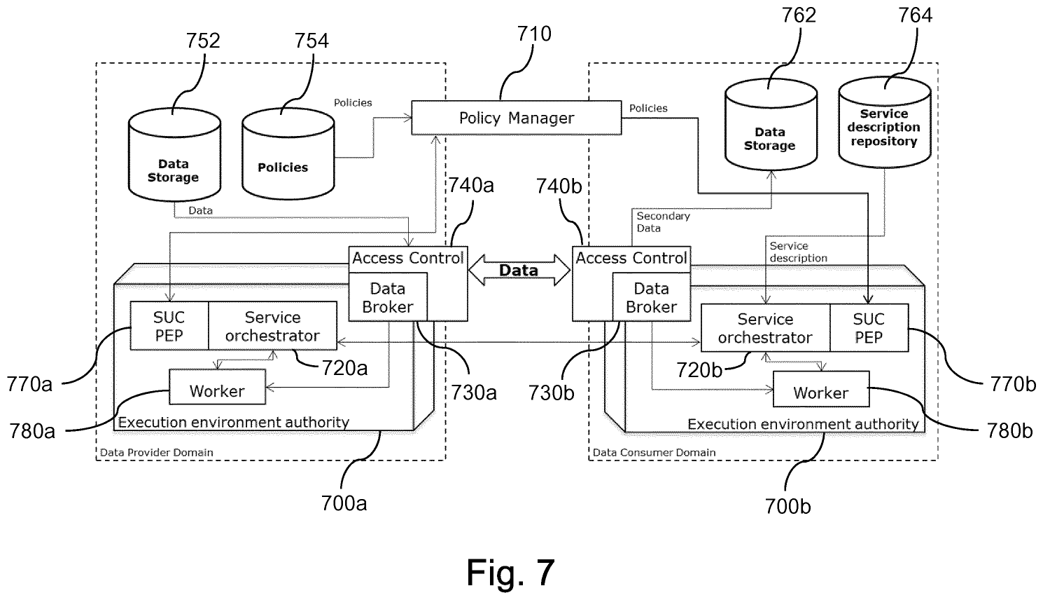

According to embodiments of the invention, with regard to the service specification by a data consumer it may be provided that a service is designed as a combination of processing functions. The services may be stored into a service description repository (e.g. in service description repositories 664 or 764, as shown in FIGS. 6 and 7, respectively). A processing function ƒ(⋅) of a service may be specified as:

$$( {y}_{1} , {y}_{2} , … , {y}_{m} ) = f ( {x}_{1} , {x}_{2} , … , {x}_{n} ) ,$$

where xᵢ denotes some input data (contained in the original data) and yᵢ denotes outputs of secondary/processed data.

Instead of using original data as inputs for processing function ƒ(⋅), the output of another function can be used. For example:

$$( {y}_{1} , {y}_{2} , … , {y}_{m} ) = f ( {x}_{1} , g ( \cdot ) , … , {x}_{n} )$$

The original input set of function g(⋅) and of function ƒ(⋅) can overlap. Function g(⋅) might be also a combination of other function.

As already mentioned above, according to embodiments of the invention, a service S can be designed as a combination of functions:

$$S : {Y}_{s} = {f}_{s} ( \cdot )$$

The input xᵢ univocally identifies an original data element of a data provider such as a specific data set or a particular class of data (e.g., surveillance video data) or a specific instance of a class of data, or a processed data element from a function instance. The output y univocally identifies a processed data element from the particular function instance. In some embodiments, the unique identifiers are handled automatically by the system.

According to embodiments of the invention, the enforcement of the secondary usage policies (specified by a data owner) on a service S (specified by a data consumer) is done by matching the secondary usage policies with input data and/or with processing functions of the service S. Specifically, matching the policies may include at least one of the following steps or any combinations thereof:
Matching the “what” of the policies with xᵢ, that is the input data or the class(es) of input data of all the functions of the combination of the service S.
Matching the “purpose” of the policies with the service S name or its composing functions ƒₛ(⋅)
Matching the “to whom” of the policies with the data consumer identifier requesting the service S.

According to embodiments of the invention, enforcing secondary usage policies on the service S may further include applying the constraints specified by the policies to the output Yₛ of the service S. This may be done by deciding on and executing atomic actions. For instance, in an embodiment the method provides for generating one policy for each (y₁, y₂, . . . , yₘ). Each policy may state that y; cannot be accessed by any third parties (i.e., all third parties except original data owner and data consumer). For execution, the generated policy may be stored into a policy manager (e.g., policy manager 410 shown in FIG. 4). In another embodiment, a commands routine may be generated and send to an execution environment of the service S that stops and restarts a container instance of the service S in predefined time intervals, e.g. every two hours. In yet another embodiment, an anonymization function ƒₐ(⋅) may be prepended to the service S, i.e. the service S is modified by adding ƒₐ(⋅) to the function using the original data. For instance, if x₁ is the original data input to be anonymized, S:(y₁, y₂, . . . , yₘ)=ƒ(x₁, x₂, . . . , xₙ) is changed to S:(y₁, y₂, . . . >yₘ)=ƒ(ƒₐ(⋅x₁), x₂, . . . , xₙ). In yet another embodiment, a subscription may be generated that targets Yₛ with notification callback set as the component managing data of the original data provider. For executing this policy, the generated subscription may be instantiated to the component managing Yₛ. The above mentioned atomic actions may be decided and executed in isolation or in any combination with each other.

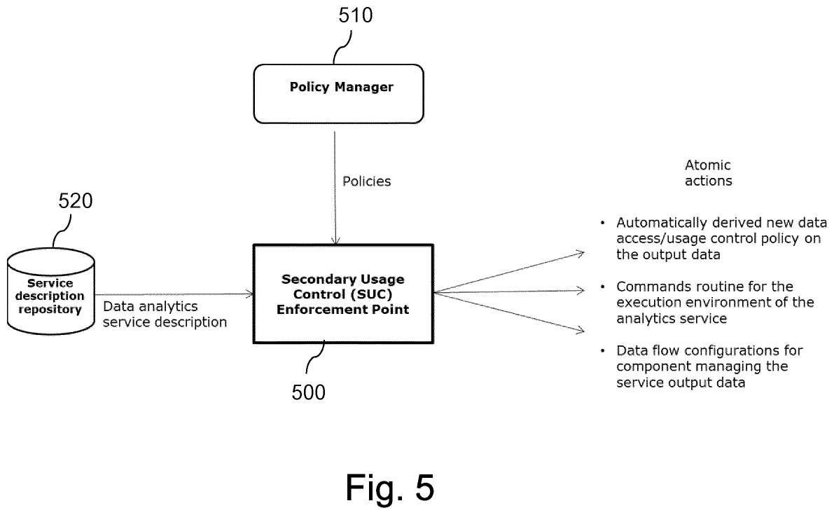

In some embodiments, a constraint might enforce the creation of an access control policy on the output yₛ (e.g., not share with other parties, access granted to original data owner, etc.). In this case, as shown in FIG. 5, a Secondary Usage Control policy enforcement point (SUC PEP) component 500, which is configured to receive policies from a policy manager 510 and data analytics service description from a service description repository 520, may generate one atomic action on the output yₛ. This atomic action may be executed by storing the newly generated policy. This method implements an automatic policies generator.

In other embodiments, the constraint might enforce the creation of data usage control policy on the output yₛ (e.g., aggregate yₛ with other data before further use). Also in this case, the SUC PEP 500 may decide to generate new policies covering the data usage control covering yₛ that will be stored.

Some embodiments might instruct the execution environment to apply runtime commands/instructions (e.g., delete output data yₛ in regular time intervals, for instance every two hours). In this case, the SUC PEP 500 may generate a routine with a timer into the execution environment to flush the process memory of the analytics service (e.g., by stopping and restarting a container).

### Application Scenario 1: Centralized Authority

FIG. 6 illustrates an embodiment of the present invention where the secondary data usage control is enforced by a centralized authority 600. The centralized authority 600 holds the data and the execution environment where data is processed.

According to an embodiment, the centralized authority 600 may offer three interfaces: 1) A policy manager 610, where a data provider 650 can set policies 654, in particular secondary usage policies. 2) A service orchestrator 620 where a data consumer 660 can send the service description (e.g. from a service description repository 664). 3) A data broker 630 protected by an access control system 640 where a data provider 650 can submit its data (e.g. from data storage 654) and where data consumers 660 retrieve secondary data (e.g. to be stored in their data storage 662).

According to the illustrated embodiment, the centralized authority 600 further comprises a Secondary Data Usage Control Policy Enforcement Point (SUC PEP) 670 that may be triggered once a new service description is submitted to the service orchestrator 620. The SUC PEP 670 may be configured to use the secondary data usage control policies from the policy manager 610 to makes decisions. The decisions may be either to generate new policies (access, data usage or secondary usage control), or to alter the functioning of the data management system (i.e., in particular the Data Broker 630 shown in FIG. 6), to alter the service description by imposing data pre- or post-processing functions, or to alter the processing of the processing nodes, namely workers 680. After the decisions from the SUC PEP 670, the functions of the service, possibly modified by the SUC PEP 670, may be instantiated into the workers 680. To this end, the SUC PEP 670 may be configured to transmit respective run-time instructions to the workers 680.

The data consumer 660 might retrieve the secondary data if allowed by the data provider policies 654. Alternatively, the data consumer 660 or another consumer might use the secondary data for further processing, if the data provider policies 654 allow it.

### Application Scenario 2: Federation of Authorities

FIG. 7 illustrates an embodiment of the present invention where the secondary data usage control is enforced by a federation of authorities 700. While the illustrated embodiment, for the sake of clarity, illustrates a federation of only two authorities, namely execution environment authority 700a located in the data provider domain and execution environment authority 700b located in the data consumer domain, it will be appreciated by those skilled in the art that in practical deployments the federation may include a higher number of authorities.

The exposed interfaces for the data consumers and data providers are the same as in the embodiment described above in connection with FIG. 6: i) a policy manager 710 where the data provider sets policies, ii) a service orchestrator 720a, 720b where the data consumer sends the service description, iii) a data broker 730a, 730b protected by an access control system 740a, 740b where a data provider submits its data and data consumers retrieve secondary data.

In the illustrated embodiment, the federated authorities 700a, 700b share the same policy manager 710. However, in some other embodiments, also this component can be federated. In yet some other embodiments, the policy manager 710 can be distributed.

According to the illustrated embodiment, a data provider sets policies 754 into the policy manager 710 and sends the original data to the data broker 730a of the local execution environment authority 700a. A data consumers submits the service description from its service description repository 764 to the service orchestrator 720b of its local execution environment authority 700b.

The two execution environment authorities 700a, 700b may be configured to exchange between each other the service descriptions in order to have a distributed decision on the policies among the SUC PEPs 770a, 770b. In some embodiments, the service descriptions might be stored into a centralized component such as the service registry similar to the policy manager 710. In such case, the data consumer would have to submit only the service name to the local service orchestrator 720b to trigger the service. In other embodiments, this service registry might be a distributed component.

### Application Scenario 3: Digital Twin for Healthcare

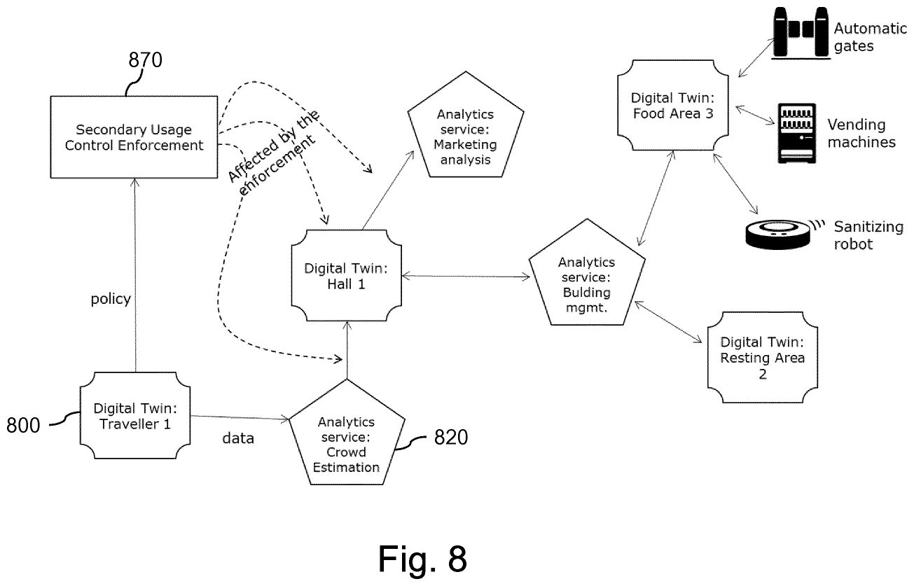

Embodiments of the present invention fit very well for digital twin scenarios, for example a healthcare scenario, as schematically illustrated in FIG. 8. A digital twin is a digital representation of a real world object or person. Digital twins are linked with each other as objects and persons are linked in the real world. Digital twins are connected with each other through analytics services.

A prominent use case for e-health, which is schematically illustrated in FIG. 8, is the monitoring of disease spread and building management to minimize the risks of contagion within indoor environments. For example, traveling persons arriving at an airport might share their current location and travelling data to the airport infrastructure that monitors the contact tracing between persons. Airport administration computes the status of different areas of the airport and the possible encountering between persons. The airport is using the data from the travellers to estimate the usage of different types of common spaces (e.g., restauration areas with vending machines, resting areas, entertainment areas, restrooms). These estimations may be used by the building management to open or close common areas on the needs. For example, if at certain time of the day the number of people seeking for entertainment is decreasing, the total size of entertainment areas might be reduced, for example, by closing gates, reducing HVAC and switching off lights. Once closed, those areas can go through automatic sanitizing procedures to make the areas disinfected from disease agents. This optimal building management is advantageous for the airport since it minimizes the usage of energy for areas management, it minimizes the areas to be sanitized, and increase the control over the overall airport. On the other side, the travellers experience a better service since areas are opened on the needs and sanitized when less needed, and they are passing and stationing on areas with high standards of sanitization.

Travellers might agree on sharing their tracing information for the benefits they get back (e.g., better user experience), but usually they want to avoid that their information is used for marketing analysis. Thus, the travellers 800 can protect how a crowd estimation 820 derived from their data is used by registering a secondary (processing) data policy at a SUC PEP 870 stating, among other information, the purpose of data usage. Such policy might be easily configured by agreeing or disagreeing with a “terms and conditions” contract on their own smartphone when connecting to the local wireless network of the airport.

In other embodiments, the personal data might be covered by secondary usage control policies decided by the single persons or by regulation (e.g., GDPR). The secondary usage control enforcement depicted in FIG. 8 can be configured to affect the managing of secondary data (aka processed data), the linked digital twin, and third part services, as shown in FIG. 8.

### Application Scenario 4: Digital Twin for Industry 4.0

Data sharing technologies are an important enabler for industry 4.0 scenarios where producers and suppliers need to interact for efficient production.

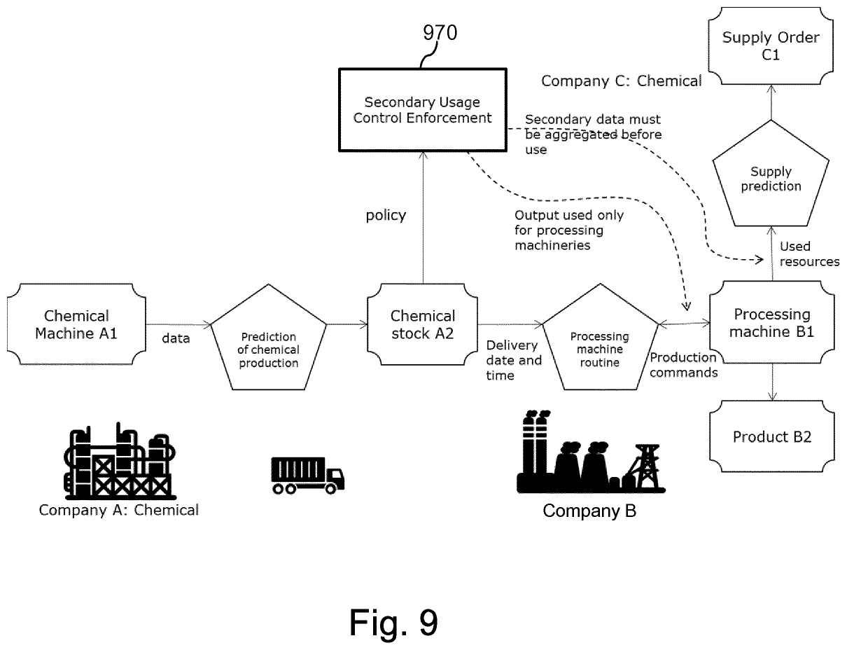

Assuming the scenario depicted in FIG. 9, three industrial companies cooperate with each other. Company A has a chemical plant that produces basic chemicals for other processing companies, such as Company B. Company A and Company B are assumed to be located in the same industrial area since the transportation and storage of some materials are expensive, thus it is better to have them shipped and used as quick as possible to reduce costs.

Company B produces different kind of materials with its machineries. For a specific product B2, Company B uses machine B1 and awaits for the supply of a certain chemical stock A2 from Company A. Chemical stock A2 is assumed to be expensive to be stored for long time, thus it is better to have it used quickly.

As shown in FIG. 9, company A uses the data from the chemical machine A1 to predict when the chemical stock A2 is ready to be delivered. When the stock is ready it is transported through dedicated tubes or with autonomous driving trucks. The information of the predicted stock delivered is used by the processing machine routine that commands processing machine B1 to automatically complete any production that machine B1 is doing in order to start the production of product B2.

The information of processing machine B1 is used by a centralized storage system to predict the needed supply by the processing plant of Company B to make the supply order C1 to company C.

Company A is a specialized chemical company and it is assumed that they want to keep their production lines secret. Thus, by applying a method according to the present invention as disclosed herein, it can be enforced via the SUC PEP 970 that the prediction of chemical stock A2 can be used by company B only to command their local machine (as indicated by the lower dotted line in FIG. 9).

Further, as indicated by the upper dotted line in FIG. 9, it can be enforced via the SUC PEP 970 that the supply prediction analytics can use the data from the processing machine B1 only aggregated with data coming from other machineries. With the protection of this secondary data, company C cannot infer how much impact the supply from company A affects the supply order C1.

Without technical enforcement of the secondary data usage control disclosed by this invention the information might be protected only by legal agreements that can be enforced only after a possible data leakage has been detected.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method of enforcing secondary data usage control, the method comprising:
providing, via a policy manager, secondary data usage policies of a data owner of original data;
providing, via a service orchestrator, a description of a service intended to be applied by a data consumer to input data contained in the original data, the service including one or more data processing functions;
matching, by a secondary usage control policy enforcement point (SUC PEP) component, the secondary data usage policies provided via the policy manager with the input data or specific classes of the input data and/or with data processing functions of the service provided via the service orchestrator; and
applying, by the SUC PEP component, the matched secondary usage policies on the secondary data.

2. The method according to claim 1, wherein the description of the service is provided as a composition of analytic tasks.

3. The method according to claim 2, wherein each of the analytics tasks of the composition of analytic tasks is defined by the input data or specific classes of the input data, a data processing function, and output data.

4. The method according to claim 1, wherein secondary data usage policies define the owner of the original data, the data targeted by the policy, the data consumer to whom the policy applies, at least one function targeted by the policy and at least one constraint specifying limitations on the usage of the targeted data.

5. The method according to claim 1, wherein applying the matched secondary usage policies on the secondary data comprises deciding on and then executing atomic actions that enforce creation of new access or data usage control policies targeting output data.

6. The method according to claim 1, wherein applying the matched secondary usage policies on the secondary data comprises deciding on and then executing atomic actions that enforce instructions for a component that executes the service applied to the original data and/or for a component that handles the secondary data.

7. The method according to claim 1, wherein an atomic action comprises:
generating a policy for each set of output data specifying that the respective set cannot be accessed by any third parties except the original data owner and the data consumer; and
storing the generated policy into the policy manager.

8. The method according to claim 1, wherein an atomic action comprises:
generating a command routine for at least one processing node that execute the data processing functions of the service to alter the execution of the service; and
sending the command routine to an execution environment of the service.

9. The method according to claim 1, wherein an atomic action comprises:
modifying the service by prepending a processing function to the original data or appending a processing function to processed data.

10. A system for enforcing secondary data usage control, the system comprising:
a policy manager configured to provide secondary data usage policies of a data owner of original data;
a service orchestrator configured to provide a description of a service intended to be applied by a data consumer to input data contained in the original data, the service including one or more data processing functions; and
a secondary usage control policy enforcement point (SUC PEP) component configured to:
match the secondary data usage policies provided via the policy manager with the input data or specific classes of the input data and/or with data processing functions of the service provided via the service orchestrator, and
apply the matched secondary usage policies on the secondary data.

11. The system according to claim 10, further comprising a data management system including a data broker protected by an access control system configured to receive the original data from the data owner and to provide the secondary data to the data consumer.

12. The system according to claim 11, wherein the SUC PEP component is configured to use the secondary data usage control policies from the policy manager to makes decisions, wherein the decisions relate to at least one of generating new policies, altering the functioning of the data management system, altering the service description by imposing data pre- or post-processing functions, and altering the processing of the processing nodes that execute the processing functions of the service.

13. The system according to claim 11, wherein the data management system, the policy manager, the service orchestrator and the SUC PEP component are part of a centralized execution environment authority.

14. The system according to claim 11, wherein the data management system, the service orchestrator and the SUC PEP component are constructed to build up a federation of execution environment authorities.

15. The system according to claim 14, wherein the federation of execution environment authorities share a policy manager.
